(19) United States
(12) Patent Application Publication
(10) Pub. No.: US 2026/0027436 A1
(43) Pub. Date: Jan. 29, 2026

(54) FENCING REACTION TIME TRAINING ASSEMBLY AND METHOD OF USE

(71) Applicant: Alan Donald Peterson, Carver, MN (US)

(72) Inventor: Alan Donald Peterson, Carver, MN (US)

(21) Appl. No.: 19/025,309

(22) Filed: Jan. 16, 2025

Related U.S. Application Data
(63) Continuation-in-part of application No. 18/873,791, filed on Jan. 1, 0001.

(51) Int. Cl. A63B 69/02; A63B 71/06

(52) U.S. Cl. CPC A63B 69/02; A63B 71/0622; A63B 2071/0655; A63B 2071/0675; A63B 2214/00; A63B 2220/40; A63B 2220/56; A63B 2220/62; A63B 2220/801; A63B 2220/833

(57) ABSTRACT

A fencing reaction time training assembly for improving thrust and lunge performance includes a fencing sword, a notification module, and a controller. The fencing sword comprises a grip and a blade. The blade, attached to the grip, includes a tip having a contact switch attached thereto. The notification module provides a sensory cue to a user to prompt the user to thrust the fencing sword to complete a touch of the tip upon an object, whereupon the contact switch is actuated and a touch signal is generated. The controller is operationally engaged to the contact switch and the notification module. The controller is programmed to randomly actuate the notification module to generate the sensory cue, to receive the touch signal, and to calculate an exercise time based on a time differential between the actuation of the notification module and receipt of the touch signal.

### CROSS-REFERENCE TO RELATED APPLICATIONS

This application is a continuation in part of application Ser. No. 18/873,791 filed Dec. 9, 2024.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to fencing training assemblies and more particularly pertains to a new fencing training assembly for improving thrust and lunge performance by a fencer.

### (2) Description of Related Art including information disclosed under 37 CFR 1.97 and 1.98.

The prior art relates to fencing training assemblies, which generally require a dedicated and conductive target to function. What is lacking in the prior art is a fencing training assembly comprising a sword tip attachable contact sensor that can detect a successful thrust to any solid target. Additionally lacking is a fencing training assembly including a motion sensor to provide additional information regarding reaction time and execution time for thrust and lunge movements.

### BRIEF SUMMARY OF THE INVENTION

An embodiment of the disclosure meets the needs presented above by generally comprising a fencing sword, a notification module, and a controller. The fencing sword comprises a grip and a blade. The blade is attached to and extends from the grip and the blade has an end defining a tip. A contact switch is attached to the tip. The notification module provides a sensory cue to a user to prompt the user to thrust the fencing sword to complete a touch of the tip upon an object, whereupon the contact switch is actuated, and a touch signal is generated. The controller is operationally engaged to the contact switch and the notification module. The controller is programmed to randomly actuate the notification module to generate the sensory cue, to receive the touch signal, and to calculate an exercise time based on a time differential between the actuation of the notification module and receipt of the touch signal.

Another embodiment of the disclosure includes a method of training for improving reaction times in fencing. The method entails provision of a fencing reaction time training assembly, according to the disclosure above. Additional steps of the method include selecting a training regimen, customizing the training regimen, starting the training regimen, executing a thrust or lunge regimen, viewing results of the training regimen on the display screen, and repeating as required to improve reaction times.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a block diagram of a fencing reaction time training assembly according to an embodiment of the disclosure.

FIG. 2 is an isometric perspective view of an embodiment of the disclosure.

FIG. 3 is a detail view of an embodiment of the disclosure.

FIG. 4 is an in-use view of an embodiment of the disclosure.

FIG. 5 is a flow diagram for a method utilizing an embodiment of the disclosure.

### DETAILED DESCRIPTION OF THE INVENTION

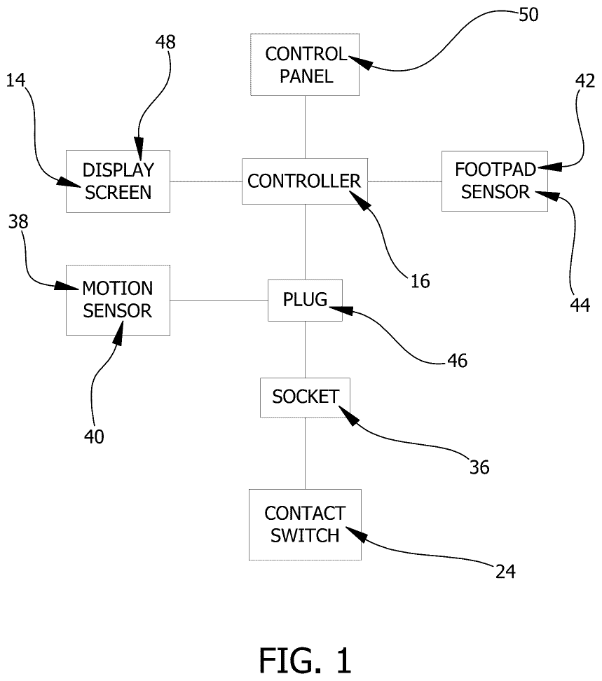

With reference now to the drawings, and in particular to FIGS. 1 through 5 thereof, a new fencing training assembly embodying the principles and concepts of an embodiment of the disclosure and generally designated by the reference numeral 10 will be described.

As best illustrated in FIGS. 1 through 5, the fencing reaction time training assembly 10 generally comprises a fencing sword 12, a notification module 14, and a controller 16. The fencing sword 12 is fairly generic to the fencing arts and includes a grip 18 and a blade 20, which is attached to and extends from the grip 18. The end of the blade 20 defines a tip 22. It should be understood that the fencing sword may comprise a foil, épée, or sabre fencing sword. A contact switch 24 is attached to the tip 22. The notification module 14 provides a sensory cue to a user to prompt the user to thrust the fencing sword 12 to complete a touch of the tip 22 upon an object 26, whereupon the contact switch 24 is actuated and a touch signal is generated. The controller 16 is operationally engaged to the contact switch 24 and the notification module 14. The controller 16 is programmed to randomly actuate the notification module 14 to generate the sensory cue, to receive the touch signal, and to calculate an exercise time based on a time differential between the actuation of the notification module 14 and receipt of the touch signal. The controller 16 typically will be programmed to execute a number of repetitions, with each repetition comprising actuation of the notification module 14 at a random interval and receipt of a touch signal. The controller 16 is programmed to calculate an exercise time for each repetition.

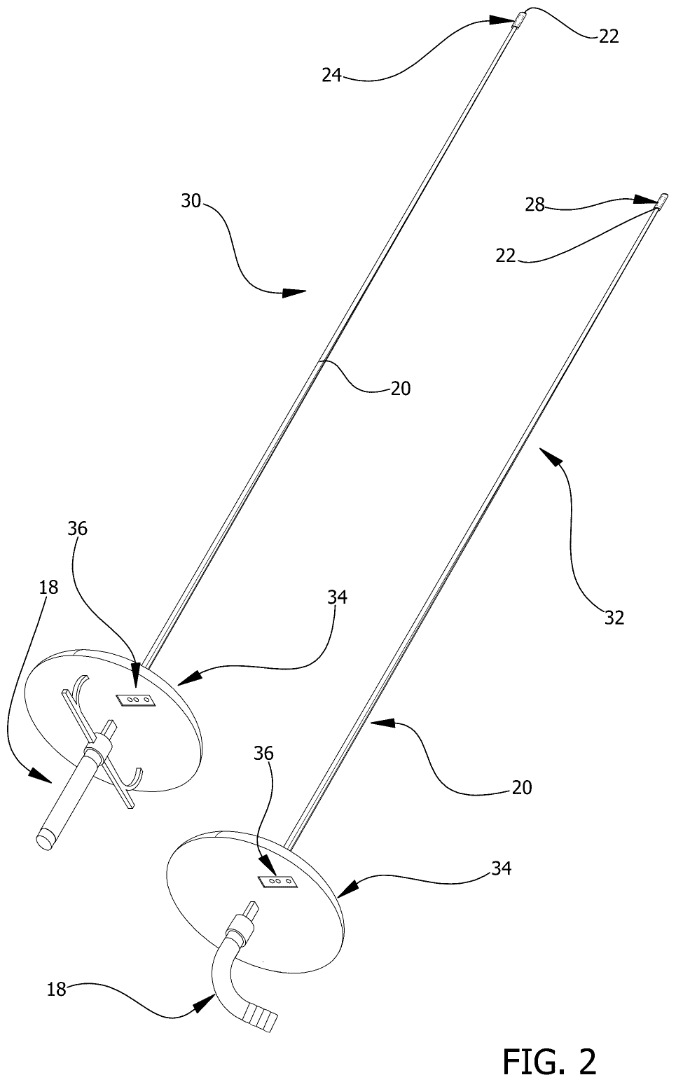

In a first configuration, the fencing sword 12 comprises an electrical point 28 attached to the tip 22, as would be required for a fencing sword 12 used competitively, as is shown in FIG. 2. Application of the present invention allows such a fencing sword 12 to be used for training purposes to improve reaction times. The contact switch 24 is integral to the electrical point 28. The fencing sword 12 may comprise a foil 30, wherein the contact switch 24 is normally closed and the touch signal corresponds to opening of a circuit, or the fencing sword 12 may comprise an épée 32, wherein the contact switch 24 is normally open and the touch signal corresponds to closing of a circuit.

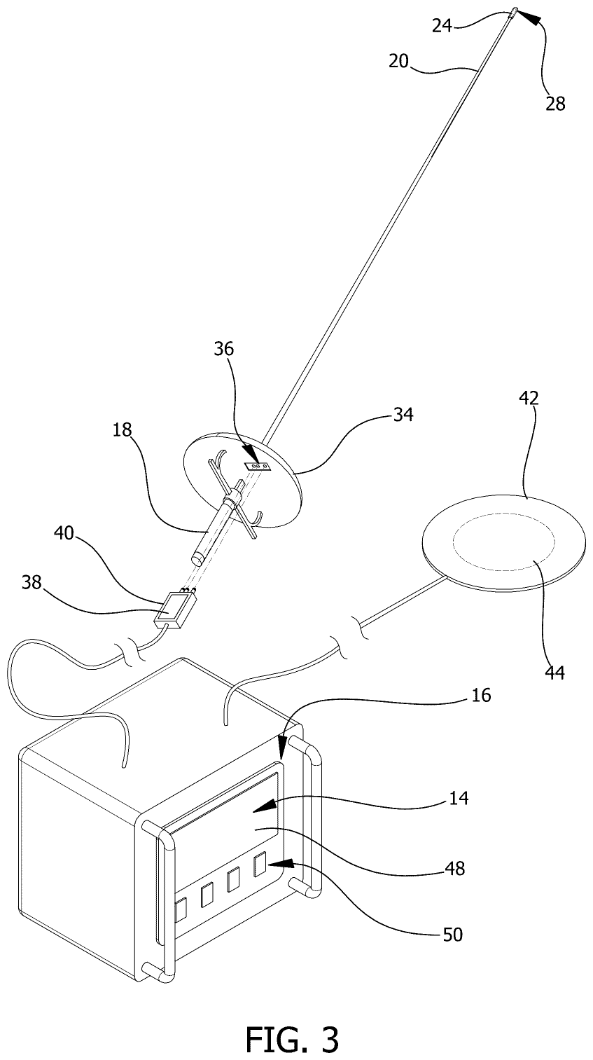

The fencing sword 12 also comprises a guard 34, which is attached to the blade 20 adjacent to the grip 18 and which extends radially from the blade 20. As is shown in FIG. 3, a socket 36 is attached to the guard 34 and is electrically engaged to the contact switch 24. The controller 16 is operationally engaged to the contact switch 24 via the socket 36.

The fencing reaction time training assembly 10 may comprise a motion sensor 38, which is operationally engaged to the controller 16 and which is configured to be selectively attachable to the socket 36. The motion sensor 38 may comprise an accelerometer 40, which typically would be a micro-electro-mechanical systems device, but which also could comprise a string potentiometer. In addition to detecting motion, the accelerometer 40 enables acceleration measurements of the fencing sword 12 to be captured and communicated to the controller 16. The acceleration measurements can be integrated to determine velocity. A motion signal is generated upon initiation of the thrust of the fencing sword 12 and communicated to the controller 16. The controller 16 is programmed to determine:
i. a thrust reaction time based on a time differential between actuation of the notification module 14 and receipt of the motion signal,
ii. an execution time based on a time differential between receipt of the motion signal and receipt of the touch signal,
iii. the exercise time as the time differential between actuation of the notification module 14 and receipt of the touch signal, and
iv. fencing sword 12 velocity calculated from the acceleration values provided by the accelerometer 40 as well as other variables from data from the accelerometer 40 (Roll, Pitch and Yaw) that the user or a coach can use to diagnose time consuming actions by the fencer.

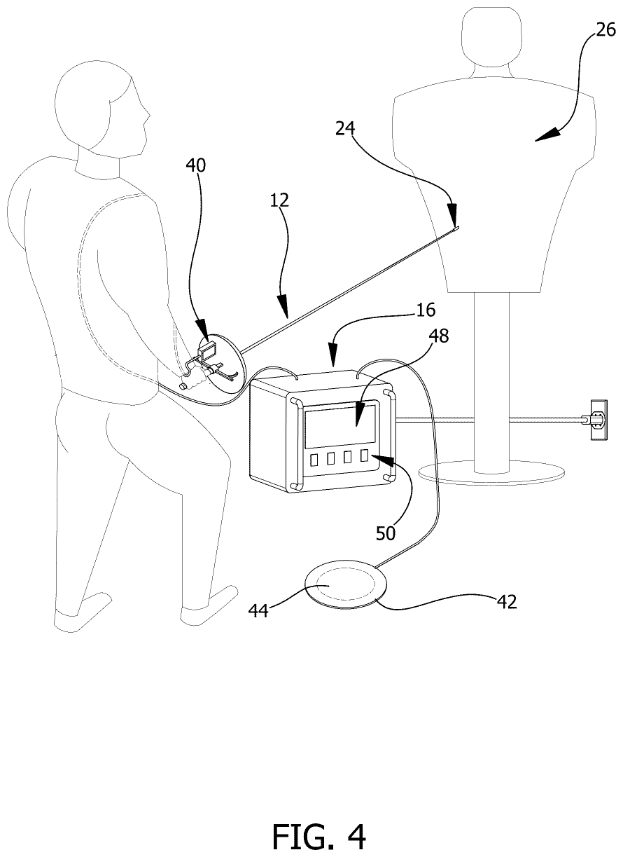

The fencing reaction time training assembly 10 also may include a footpad sensor 42, which is configured to be positioned on a surface between the user and the object 26 and to accept a foot of the user who is executing a lunge movement, as is shown in FIG. 4. Another anticipated use of the footpad sensor 42 is simply for positioning of the foot of the user when assuming an “en garde”position prior to executing a thrust.

The footpad sensor 42 may include a pressure sensor 44 that is actuated upon positioning of the foot upon the footpad sensor 42. Other sensing means could be used, such as, but not limited to, proximity sensors, light beam sensors, or the like. An advantage in using the pressure sensor 44 is that it can measure the pressure applied by the foot and use that to determine the proper weight distribution on the fencer's feet. The footpad sensor 42 may include a light emitting diode that illuminates if the foot is not properly positioned or the fencer's weight is not properly distributed. The footpad sensor 42 is in communicative engagement with the controller 16 so that, upon random actuation of the notification module 14 to generate the sensory cue, the controller 16 receives a lunge signal from the footpad sensor 42 when the user executes the lunge movement.

The controller 16 is programmed to determine a lunge reaction time between actuation of the notification module 14 and receipt of the lunge signal. When the footpad sensor 42 is in use for lunge training, the lunge reaction time is calculated in place of the thrust reaction time. The execution time and the exercise time are calculated in the same manner as for thrust training. The present invention also anticipates the footpad sensor 42 being attached to the foot of the user.

Typically, in the first configuration, each of the electrical point 28, the footpad sensor 42, and the motion sensor 38 are electrically connected to the controller 16. In one example, as shown in FIG. 3, the motion sensor 38 is mounted to and wired to a plug 46 that is complementary to the socket 36, thereby allowing both the contact switch 24 and the motion sensor 38 to communicate with the controller 16 via a wired connection. The present invention also anticipates the motion sensor 38 being releasably attachable to the guard 34 so that it is opposingly positioned relative to the grip 18.

While the typical construction of a fencing sword allows for efficiently utilizing wired connections, the present invention also anticipates the assembly 10 being wireless, with the contact switch 24 and the motion sensor 38 being paired with a first transmitter and first battery (not shown) and the footpad sensor 42 being paired with a second transmitter and a second battery (not shown). The controller 16 would be equipped with a receiver (not shown). Additionally anticipated by the present invention is a personal electronic device of the user, such as smartphone, tablet computer, laptop computer, or the like, being programmed to function as the controller 16 and being in wireless communication with the contact switch 24 and motion sensor 38, via the first transmitter, and with the footpad sensor 42, via the second transmitter. Additionally anticipated by the present invention is the motion sensor 38 comprising an accelerometer 40 that is integral to a smart watch or to a smart ring, with the smart watch or the smart ring being in wireless communication with the controller 16.

Typically, the notification module 14 includes a display screen 48 and the sensory cue is visual. As is shown in FIG. 3, the display screen 48 is attached to the controller 16, although the present invention anticipates the display screen 48 as a separate component. As will become apparent, the display screen 48 is advantageous as it allows presentation of other parameters relevant to reaction time training. However, the present invention also anticipates the notification module 14 comprising a sound emitter providing an audible cue, as well as a body mountable vibrator, thereby providing a vibratory cue.

A control panel 50 is attached to the controller 16, which is programmed to accept commands from the control panel 50 to allow the user to select a training regimen, customize the training regimen, start the training regimen, and view the results of the training regimen on the display screen 48. A typical control panel 50 is shown in FIG. 3. Also anticipated is the display screen 48 being touch enabled and the control panel 50 being emulated on the display screen 48.

While in the first configuration the contact switch 24 is integral to the electrical point 28 of a standard fencing sword 12, thus providing an easy method 52 to practice the present invention, a second configuration is anticipated wherein the contact switch 24 is attachable to the tip 22 using conventional connectors such as screw clamps, spring clamps, magnets, elastic bands, pressure sensitive adhesives, friction fitting, or the like. The contact switch 24 may comprise a miniature snap-action switch, a piezo touch switch, a mutual capacitive touch switch, or a resistance touch switch, although the latter would limit materials used for the object 26 to those that are conductive. As above, a motion sensor 38 is operationally engaged to the controller 16 and is configured to be selectively attachable to the fencing sword 12. Also as above, a footpad sensor 42 may be included for use in executing a lunge movement.

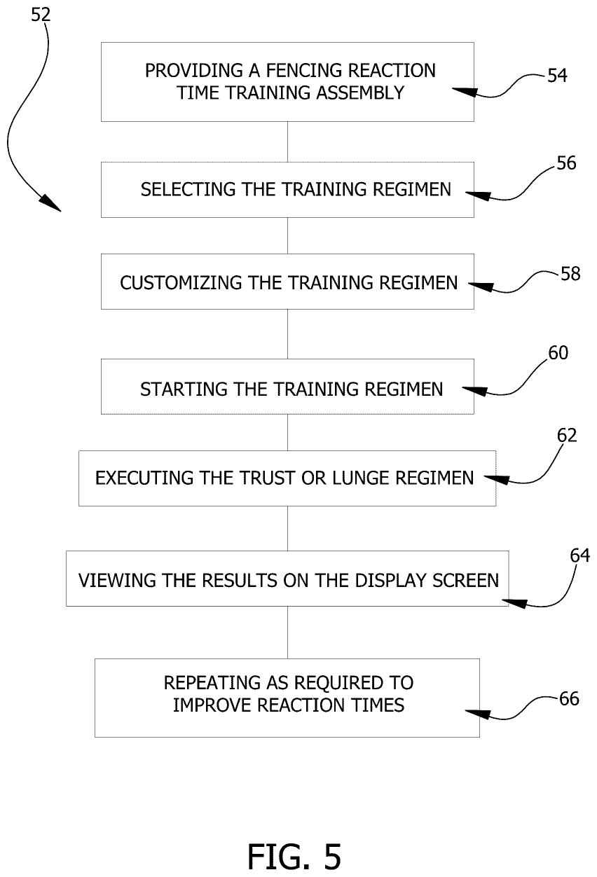

In use, the fencing reaction time training assembly 10 enables a method of training for improving reaction times in fencing 52. As is shown in FIG. 5, the method 52 comprises a first step 54 of providing a fencing reaction time training assembly 10, according to the specification above. A second step 56 of the method 52 is selecting the training regimen and a third step 58 includes customizing of the training regimen. The second step 56 and third steps 58 allow the user to select number of thrusts, amount of random time between thrusts, whether or not motion sensors will be utilized, and the like. Starting the training regimen is the fourth step 60. A fifth step 62 of the method 52 is executing the thrust or lunge regimen. Finally, a sixth step 64 of the method 52 includes viewing the results of the training regimen on the display screen 48 while a seventh step 66 of the method 52 may comprise repeating the prior steps as required to improve reaction times.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fencing reaction time training assembly comprising:
a fencing sword comprising:
a grip;
a blade being attached to and extending from the grip and having an end defining a tip; and
a contact switch being attached to the tip;
a notification module providing a sensory cue to a user for prompting the user to thrust the fencing sword to complete a touch of the tip upon an object whereupon the contact switch is actuated and a touch signal is generated; and
a controller being operationally engaged to the contact switch and the notification module, the controller being programmed to randomly actuate the notification module to generate the sensory cue, to receive the touch signal, and to calculate an exercise time based on a time differential between the actuation of the notification module and receipt of the touch signal.

2. The fencing reaction time training assembly of claim 1, wherein the fencing sword comprises an electrical point, the electrical point being attached to the tip, contact switch being integral to the electrical point.

3. The fencing reaction time training assembly of claim 2, wherein the fencing sword comprises:
a foil and the contact switch is normally closed, wherein the touch signal corresponds to opening of a circuit; or
an épée and the contact switch is normally open, wherein the touch signal corresponds to closing of a circuit.

4. The fencing reaction time training assembly of claim 2, wherein:
the fencing sword comprises:
a guard being attached to the blade adjacent to the grip and extending radially from the blade; and
a socket being attached to the guard and electrically engaged to the contact switch; and
the controller is operationally engaged to the contact switch via the socket.

5. The fencing reaction time training assembly of claim 4, further comprising:
a motion sensor being operationally engaged to the controller and being configured to be selectively attachable to the socket such that a motion signal is generated upon initiation of the thrust of the fencing sword and communicated to the controller; and
the controller being programmed to determine:
a thrust reaction time based on a time differential between actuation of the notification module and receipt of the motion signal;
an execution time based on a time differential between receipt of the motion signal and receipt of the touch signal; and
the exercise time as the time differential between actuation of the notification module and receipt of the touch signal.

6. The fencing reaction time training assembly of claim 5, wherein the motion sensor comprises an accelerometer such that acceleration measurements of the fencing sword can be captured and communicated to the controller.

7. The fencing reaction time training assembly of claim 5, further comprising:
a footpad sensor being configured for positioning on a surface between the user and the object and for accepting a foot of the user executing a lunge movement, the footpad sensor and being in communicative engagement with the controller such that, upon random actuation of the notification module to generate the sensory cue, the controller receives a lunge signal from the footpad sensor when the user executes the lunge movement; and
the controller being programmed to determine a lunge reaction time as the time differential between actuation of the notification module and receipt of the lunge signal.

8. The fencing reaction time training assembly of claim 7, wherein the footpad sensor comprises a pressure sensor.

9. The fencing reaction time training assembly of claim 7, further comprising each of the electrical point, the footpad sensor, and the motion sensor being electrically connected to the controller.

10. The fencing reaction time training assembly of claim 1, wherein:
the controller is programmed to execute a number of repetitions, each repetition comprising actuation of the notification module at a random interval and receipt of a touch signal; and
the controller is programmed to calculate an exercise time for each repetition.

11. The fencing reaction time training assembly of claim 1, wherein the notification module comprises a display screen.

12. The fencing reaction time training assembly of claim 11, wherein the display screen is attached to the controller.

13. The fencing reaction time training assembly of claim 11, further comprising:
a control panel being attached to the controller; and
the controller being programmed to accept commands from the control panel allowing the user to select a training regimen, to customize the training regimen, to start the training regimen, and to view the results of the training regimen on the display screen.

14. The fencing reaction time training assembly of claim 1, further comprising
a motion sensor being operationally engaged to the controller and being configured to be selectively attachable to the fencing sword such that a motion signal is generated upon initiation of the thrust of the fencing sword and communicated to the controller; and
the controller being programmed to determine:
a reaction time based on a time differential between actuation of the notification module and receipt of the motion signal;
an execution time based on a time differential between receipt of the motion signal and receipt of the touch signal; and
the exercise time as the time differential between actuation of the notification module and receipt of the touch signal.

15. The fencing reaction time training assembly of claim 14, further comprising:
a footpad sensor being configured for positioning on a surface between the user and the object and for accepting a foot of the user executing a lunge movement, the footpad sensor and being in communicative engagement with the controller such that, upon random actuation of the notification module to generate the sensory cue, the controller receives a lunge signal from the footpad sensor when the user executes the lunge movement; and
the controller being programmed to determine a lunge reaction time as the time differential between actuation of the notification module and receipt of the lunge signal.

16. The fencing reaction time training assembly of claim 15, wherein:
the motion sensor comprises an accelerometer such that acceleration measurements of the fencing sword can be captured and communicated to the controller; and
the footpad sensor comprises a pressure sensor.

17. The fencing reaction time training assembly of claim 15, further comprising each of the contact switch, the footpad sensor, and the motion sensor being electrically connected to the controller.

18. The fencing reaction time training assembly of claim 15, further comprising:
the controller being programmed to execute a number of repetitions, each repetition comprising actuation of the notification module at a random interval and:
receipt of the touch signal and the motion signal; or
receipt of the touch signal, the motion signal, and the lunge signal;
the controller being programmed to calculate an exercise time for each repetition;
the notification module comprising a display screen;
a control panel being attached to the controller; and
the controller being programmed to accept commands from the control panel allowing the user to select a training regimen, to customize the training regimen, to start the training regimen, and to view the results of the training regimen on the display screen.

19. A method of training for improving reaction times in fencing, the method comprising the steps of:
providing a fencing reaction time training assembly comprising:
a fencing sword comprising:
a grip;
a blade being attached to and extending from the grip defining a tip; and
a contact switch being attached to the tip;
a notification module providing a sensory cue to a user for prompting the user to thrust the fencing sword to complete a touch of the tip upon an object whereupon the contact switch is actuated and a touch signal is generated, the notification module comprising a display screen;
a motion sensor being configured to be selectively attachable to the fencing sword such that a motion signal is generated upon initiation of the thrust of the fencing sword;
a footpad sensor being configured for positioning on a surface between the user and the object and for accepting a foot of the user executing a lunge movement such that a lunge signal is generated upon the user executing the lunge movement;
a controller having a control panel attached thereto, the controller being operationally engaged to the contact switch, the notification module, the display, the motion sensor, the footpad sensor, and the control panel, the controller being programmed to randomly actuate the notification module to generate the sensory cue and to selectively receive the touch signal, the motion signal, and the lunge signal, the controller being programmed to execute a number of repetitions, each repetition comprising actuation of the notification module at a random interval and:
receipt of the motion signal and the touch signal; or
receipt of the motion signal, the lunge signal, and the touch signal;
the controller being programmed to determine, for each repetition:
a reaction time based on a time differential between actuation of the notification module and receipt of the motion signal;
an execution time based on a time differential between receipt of the motion signal and receipt of the touch signal; and
the exercise time as the time differential between actuation of the notification module and receipt of the touch signal; and
the controller being programmed to accept commands from the control panel allowing the user to select a training regimen, to customize the training regimen, to start the training regimen, and to view the results of the training regimen on the display screen.
selecting the training regimen;
customizing the training regimen;
starting the training regimen;
executing the thrust or lunge regimen;
viewing the results of the training regimen on the display screen; and
repeating as required to improve reaction times.
